(19) United States
(12) Patent Application Publication
(10) Pub. No.: US 2021/0281770 A1
(43) Pub. Date: Sep. 9, 2021

(54) MARKER

(71) Applicant: Enplas Corporation

(72) Inventor: Tomohiro SAITO, Saitama (JP)

(21) Appl. No.: 16/328,371

(22) PCT Filed: Jul. 27, 2017
(86) PCT No.: PCT/JP2017/027323

§ 371 Date: Feb. 26, 2019

(30) Foreign Application Priority Data
Aug. 26, 2016 (JP) 2016-165672

(51) Int. Cl. H04N 5/232; H04N 5/225

(52) U.S. Cl. CPC H04N 5/232945; H04N 5/2254

(57) ABSTRACT

This marker has a cylindrical lens part and a plurality of detected parts disposed so as to correspond to the cylindrical lens part. For example, the detected part is disposed so that a mark moves more from the center of the marker toward an end thereof, the detected part is disposed so that the mark moves more from one end of the marker toward the center thereof, and the detected part is disposed so that the mark moves more from the other end of the marker toward the center thereof the more the marker is inclined.

### TECHNICAL FIELD

The present invention relates to a marker.

### BACKGROUND ART

As an image indicator (marker) in which a pattern (mark) is projected onto a convex lens part having a convex surface part, an image indicating sheet including a lenticular lens and coloring layers is known. This lenticular lens has a configuration in which a plurality of cylindrical lenses are arranged side by side, and the coloring layers are disposed in respective cylindrical lenses so as to be observed as images of respective cylindrical lenses. With this configuration, a collective mark is formed by the images. The image indicating sheet is suitable for recognition of the position, orientation and the like of objects in the fields of augmented reality (AR), robotics, and the like (see, for example, PTL 1 and PTL 2).

### CITATION LIST

### Patent Literature

### PTL 1

Japanese Patent Application Laid-Open No. 2013-025043

### PTL 2

Japanese Patent Application Laid-Open No. 2012-145559

### SUMMARY OF INVENTION

### Technical Problem

FIGS. 1A and 1B illustrate an exemplary marker including a lenticular lens part. FIG. 1A is a plan view schematically illustrating the marker, and FIG. 1B illustrates a cross-section of the marker illustrated in FIG. 1A along the X direction. Note that, in the drawing, the X direction is the arrangement direction of the cylindrical lens part, and the Y direction is a plane direction of the cylindrical lens part that is orthogonal to the X direction, and the Z direction is the thickness direction of the cylindrical lens part, which is a direction orthogonal to both the X direction and the Y direction. In addition, in the drawing, arrow X1 indicates one end side in the X direction, and arrow X2 indicates the other end side in the X direction.

As illustrated in FIG. 1A and FIG. 1B, marker 10 includes lenticular lens part 11 and a plurality of detection object parts 12. Lenticular lens part 11 is an integrated member composed of a plurality of cylindrical lens parts 13 disposed in parallel in the X direction. For example, each detection object part 12 is composed of a groove formed in the rear surface of lenticular lens part 11 and a coloring part housed in the groove.

Basically, in marker 10, one detection object part 12 is disposed for each cylindrical lens part 13. In addition, the distance between detection object parts 12 adjacent to each other is slightly smaller than the distance between cylindrical lens parts 13 adjacent to each other, and detection object parts 12 are disposed such that they are closer to the center as the positions come closer to the both ends in the X direction. For example, nth detection object part 12 with respect to a certain detection object part 12 is disposed such that the center of the nth detection object part 12 in the X direction is remote from the both ends of lenticular lens part 11 by nG with respect to the central axis of cylindrical lens part 13 in which the nth detection object part 12 is disposed. G is a constant.

Next, with reference to FIG. 2A to FIG. 3C, a behavior of a mark in marker 10 is described. FIG. 2A schematically illustrates a mark when marker 10 is viewed (in the direction of arrow E1) from directly above, FIG. 2B schematically illustrates a mark when marker 10 is viewed (in the direction of arrow E2) at a slightly inclined angle from the one end side, and FIG. 2C schematically illustrates a mark when marker 10 is viewed (in the direction of arrow E3) at a further inclined angle from the one end side.

When marker 10 is viewed in the direction of arrow E1, an image of detection object parts 12 (e.g. detection object parts 12 in the dashed line frame) located at or near the center of marker 10 in the X direction is projected to the surface of lenticular lens part 11, thus forming a mark. In this manner, as illustrated in FIG. 2A, when marker 10 is viewed in the direction of arrow E1, a mark is formed at a center portion of marker 10 in the X direction.

When marker 10 is viewed in the direction of arrow E2, an image of detection object parts 12 located (in the above-mentioned frame) between the center and the one end of marker 10 in the X direction is projected to the convex surfaces of marker 10, thus forming a mark, for example. In this manner, as illustrated in FIG. 2B, when marker 10 is viewed in the direction of arrow E2, a mark is formed between the center and the one end of marker 10 in the X direction.

When marker 10 is viewed in the direction of arrow E3, an image of detection object parts 12 located (in the above-mentioned frame) at the one end portion of marker 10 in the X direction is projected to the convex surfaces of marker 10, thus forming a mark, for example. In this manner, as illustrated in FIG. 2C, when marker 10 is viewed in the direction of arrow E3, a mark is formed at a one end portion of marker 10 in the X direction.

FIG. 3A schematically illustrates a mark when marker 10 is viewed (in the direction of arrow E1) from directly above as in FIG. 2A. FIG. 3B schematically illustrates a mark when marker 10 is viewed (in the direction of arrow E4) at a slightly inclined angle from the other end side, and FIG. 3C schematically illustrates a mark when marker 10 is viewed (in the direction of arrow E5) at a further inclined angle from the other end side.

When marker 10 is viewed in the direction of arrow E4, an image of detection object parts 12 located (in the above-mentioned frame) between the center and the other end of 10 in the X direction is projected to the convex surfaces of marker 10, thus forming a mark, for example. In this manner, as illustrated in FIG. 3B, when marker 10 is viewed in the direction of arrow E4, a mark is formed between the center and the other end of marker 10 in the X direction.

When marker 10 is viewed in the direction of arrow E5, an image of detection object parts 12 located (in the above-mentioned frame) at the other end portion of marker 10 in the X direction is projected to the convex surfaces of marker 10, thus forming a mark, for example. In this manner, as illustrated in FIG. 3C, when marker 10 is viewed in the direction of arrow E5, a mark is formed at the other end portion of marker 10 in the X direction.

Thus, in marker 10, a mark is detected in accordance with a specific position or angle in the XZ plane in substantially the entire region of marker 10 from one end to the other end in the X direction. Therefore, marker 10 can be used for detection of the position or the angle of marker 10 on the basis of a detected position of a mark.

However, in some situation detection of a mark in substantially the entire region of marker 10 in X direction is difficult when the marker is used for orientation control of an object having a smaller size or when the marker is used in a narrower space. That is, the marker has a room for improvement in downsizing.

An object of the present invention is to provide a marker that can reduce the size of a part for displaying a mark.

### Solution to Problem

A marker according to an embodiment of the present invention includes: a plurality of cylindrical lens parts disposed in parallel; and a plurality of detection object parts disposed in association with the plurality of cylindrical lens parts. The plurality of detection object parts include a first detection object part group, a second detection object part group disposed on one end side in an arrangement direction of the plurality of cylindrical lens parts, and a third detection object part group disposed on the other end side in the arrangement direction. With respect to a virtual marker including a plurality of virtual cylindrical lens parts disposed in parallel and a plurality of virtual detection object parts disposed in association with the plurality of virtual cylindrical lens parts, in which the plurality of virtual detection object parts are disposed such that, when the virtual marker is viewed from a convex surface side of the plurality of virtual cylindrical lens parts while changing a viewing angle along a virtual arrangement direction of the plurality of virtual cylindrical lens parts, the plurality of virtual detection object parts form a mark that moves in one direction between one end and the other end of the plurality of virtual cylindrical lens parts in the virtual arrangement direction, the plurality of virtual detection object parts including a first virtual detection object part group disposed at a center portion in the virtual arrangement direction, a second virtual detection object part group disposed on the other end side in the virtual arrangement direction, and a third virtual detection object part group disposed on one end side in the virtual arrangement direction, an arrangement of the detection object parts of the first detection object part group is identical to an arrangement of the virtual detection object parts of the first virtual detection object part group in the virtual arrangement direction, an arrangement of the detection object parts of the second detection object part group is identical to an arrangement of the virtual detection object parts of the second virtual detection object part group in the virtual arrangement direction, an arrangement of the detection object parts of the third detection object part group is identical to an arrangement of the virtual detection object parts of the third virtual detection object part group in the virtual arrangement direction, and a first detection object part and a second detection object part are disposed in association with one of the plurality of cylindrical lens parts corresponding to any one of the detection object part in the first detection object part group, the first detection object part being one of the plurality of detection object parts of the second detection object part group, the first detection object part corresponding to the virtual detection object part closest to the other end in the virtual arrangement direction in the second virtual detection object part group, the second detection object part being one of the plurality of detection object parts of the third detection object part group, the second detection object part corresponding to the virtual detection object part closest to the one end in the virtual arrangement direction in the third virtual detection object part group.

### Advantageous Effects of Invention

The marker according to an embodiment of the present invention forms a mark such that the mark cyclically moves when the marker is viewed in an relatively inclined angle, and thus can reduce a part for displaying the mark.

### BRIEF DESCRIPTION OF DRAWINGS

FIG. 1A is a plan view schematically illustrating an example of a marker including a lenticular lens part, and FIG. 1B illustrates a cross-section of the marker illustrated in FIG. 1A along the X direction;

FIG. 2A schematically illustrates a mark when the marker is viewed from directly above, FIG. 2B schematically illustrates a mark when the marker is viewed at a slightly inclined angle from the one end side, and FIG. 2C schematically illustrates a mark when the marker is viewed at a further inclined angle from the one end side;

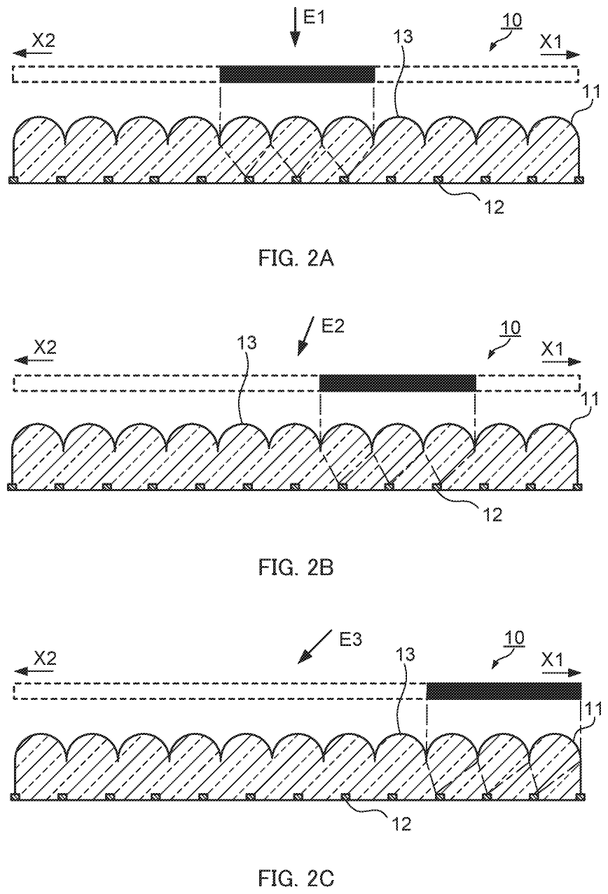

FIG. 3A schematically illustrates a mark when the marker is viewed from directly above, FIG. 3B schematically illustrates a mark when the marker is viewed at a slightly inclined angle from the other end side, and FIG. 3C schematically illustrates a mark when the marker is viewed at a further inclined angle from the other end side;

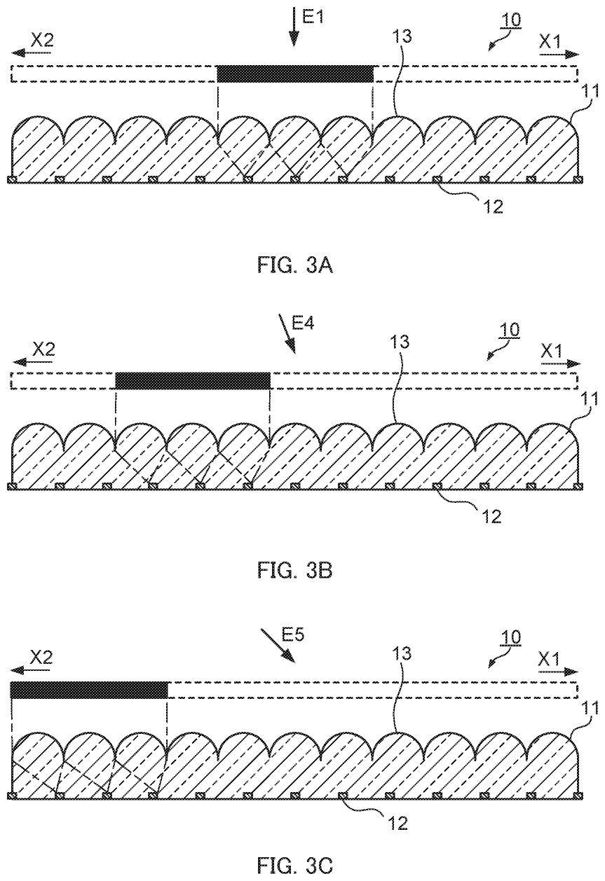

FIG. 4A is a plan view schematically illustrating a marker according to a first embodiment of the present invention, and FIG. 4B is a cross-section of the marker illustrated in FIG. 4A along the X direction;

FIG. 5A schematically illustrates an arrangement of virtual cylindrical lens parts and virtual detection object parts in a first virtual marker, FIG. 5B schematically illustrates a state where virtual detection object parts on the other end side in the first virtual marker are placed on one end side, and FIG. 5C schematically illustrates a state where virtual detection object parts on the one end side in the first virtual marker are placed on the other end side;

FIG. 6A schematically illustrates a mark that is formed when the marker according to the first embodiment is viewed from directly above, FIG. 6B schematically illustrates a position of a mark when the marker is viewed at a slightly inclined angle from the one end side, and FIG. 6C schematically illustrates a position of a mark when the marker is viewed at a further inclined angle from the one end side;

FIG. 7A schematically illustrates a mark when the marker according to the first embodiment is viewed from directly above, FIG. 7B schematically illustrates a mark when the marker is viewed at a slightly inclined angle from the other end side, and FIG. 7C schematically illustrates a mark when the marker is viewed at a further inclined angle from the other end side;

FIG. 8A schematically illustrates a plan view of a marker according to a second embodiment of the present invention, and FIG. 8B illustrates a cross-section of the marker illustrated in FIG. 8A along the X direction;

FIG. 9A schematically illustrates an arrangement of virtual cylindrical lens parts and virtual detection object parts in a second virtual marker, FIG. 9B schematically illustrates a state where virtual detection object parts on the other end side are placed on the one end side in the second virtual marker, and FIG. 9C schematically illustrates a state where virtual detection object parts on the one end side are placed on the other end side in the second virtual marker;

FIG. 10A is a plan view schematically illustrating a marker according to a third embodiment of the present invention, and FIG. 10B illustrates a cross-section of the marker illustrated in FIG. 10A along the X direction;

FIG. 11A schematically illustrates an arrangement of virtual cylindrical lens parts and virtual detection object parts in a third virtual marker, FIG. 11B schematically illustrates a state where virtual detection object parts on the other end side are placed on the one end side in the third virtual marker, and FIG. 11C schematically illustrates a state where virtual detection object parts on the one end side are placed on the other end side in the third virtual marker; and

FIG. 12A schematically illustrates a position of a mark when the marker according to the first embodiment is viewed in oblique direction E2 before a detection object part is added, and FIG. 12B schematically illustrates a position of a mark when the marker is viewed in oblique direction E2 after a detection object part is added.

### DESCRIPTION OF EMBODIMENTS

### First Embodiment

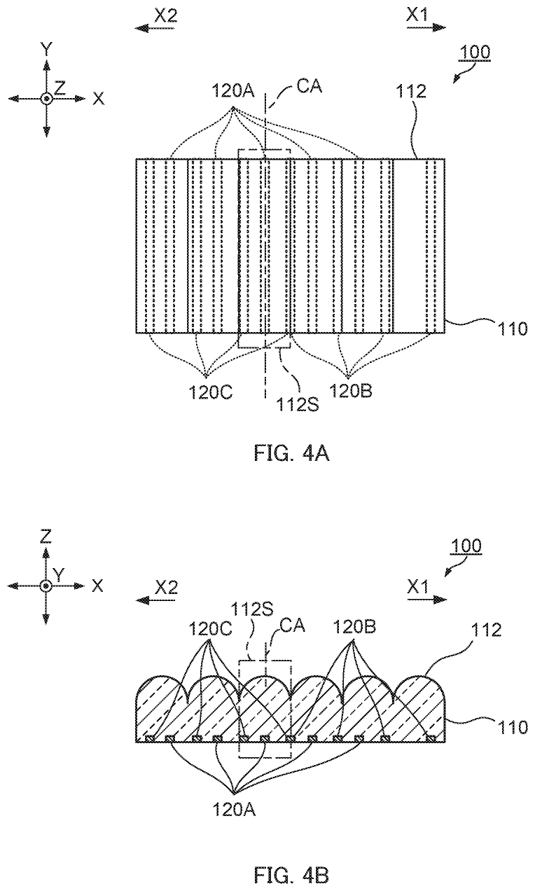

FIG. 4A is a plan view schematically illustrating marker 100 according to a first embodiment of the present invention, and FIG. 4B illustrates a cross-section of marker 100 illustrated in FIG. 4A along the X direction.

As illustrated in FIG. 4A and FIG. 4B, marker 100 includes lenticular lens part 110 including a plurality of cylindrical lens parts 112 disposed in parallel, and a plurality of detection object parts, 120A, 120B and 120C, which are disposed in association with cylindrical lens parts 112. In addition, cylindrical lens parts 112 include reference cylindrical lens part 112S including object part 120A located at the center (on central axis CA) in the X direction detection.

Lenticular lens part 110 is formed of an optically transparent material (e.g. optically transparent resin), and is composed of a plurality of cylindrical lens parts 112 disposed in parallel in the X direction. For example, lenticular lens part 110 is a mold of the above-mentioned optically transparent resin integrally including a plurality of cylindrical lens parts 112.

Each cylindrical lens part 112 is a convex lens part having a rectangular planar shape. The rectangular shape is long in the Y direction and short in the X direction. Further, each cylindrical lens part 112 is a spherical lens part. Note that the configuration in which cylindrical lens part 112 has a spherical lens part means that the convex surface part of cylindrical lens part 112 substantially has an arc optical shape in a cross-section along the XZ plane.

Each of detection object parts 120A, 120B and 120C is a portion that is detected as an image projected on the surface of lenticular lens part 110 when lenticular lens part 110 is viewed from the convex surface side. Each of detection object parts 120A, 120B and 120C is composed of a groove extending in the Y direction on the rear surface of lenticular lens part 110 and a coloring part housed in the groove, for example. The coloring part is a solidified coating material containing a colorant such as a black pigment, for example.

Of six cylindrical lens parts 112, detection object parts 120A are detection object parts that are respectively disposed in five cylindrical lens parts 112 on the other end side including reference cylindrical lens part 112S disposed at the center portion, and the entirety of detection object parts 120A corresponds to “detection object part of first detection object part group”.

Of six cylindrical lens parts 112, detection object parts 120B are detection object parts that are respectively disposed in four cylindrical lens parts 112 on one side, and the entirety of detection object parts 120B corresponds to “group detection object part of second detection object part”. Of six cylindrical lens parts 112, detection object parts 120C are detection object parts that are respectively disposed in four cylindrical lens parts 112 on the other end side, and the entirety of detection object parts 120C corresponds to “detection object part of third detection object part group”.

The detection object part 120B closest to the other end and the detection object part 120C closest to the one end overlap at one end of reference cylindrical lens part 112S, as one detection object part.

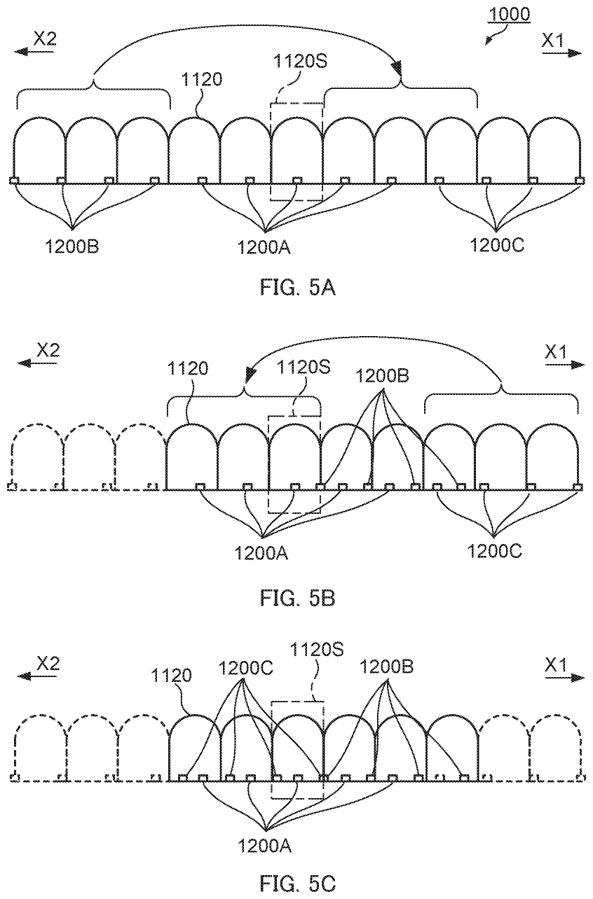

The arrangements of detection object parts 120A, 120B and 120C are described in more detail with reference to the drawings. FIG. 5A schematically illustrates an arrangement of virtual cylindrical lens parts and virtual detection object parts in a first virtual marker, FIG. 5B schematically illustrates a state where the virtual detection object parts on the other end side in the first virtual marker are placed on one end side, and FIG. 5C schematically illustrates a state where the virtual detection object parts on the one end side in the first virtual marker are placed on the other end side.

As illustrated in FIG. 5A, first virtual marker 1000 includes a plurality of (e.g. 11) virtual cylindrical lens parts 1120 disposed in parallel in the X direction, each of which includes virtual detection object part 1200A, 1200B or 1200C. Further, first virtual marker 1000 includes virtual reference cylindrical lens part 1120S including virtual detection object part 1200A at the center thereof in the X direction.

The sizes of virtual cylindrical lens part 1120 and virtual detection object parts 1200A, 1200B and 1200C of first virtual marker 1000 are equal to those of cylindrical lens part 112 and detection object parts 120A, 120B and 120C of marker 100.

The X direction corresponds to a virtual arrangement direction. In addition, the entirety of virtual detection object parts 1200A corresponds to a first virtual detection object part group, the entirety of virtual detection object parts 1200B corresponds to a second virtual detection object part group, and the entirety of virtual detection object parts 1200C corresponds to a third virtual detection object part group.

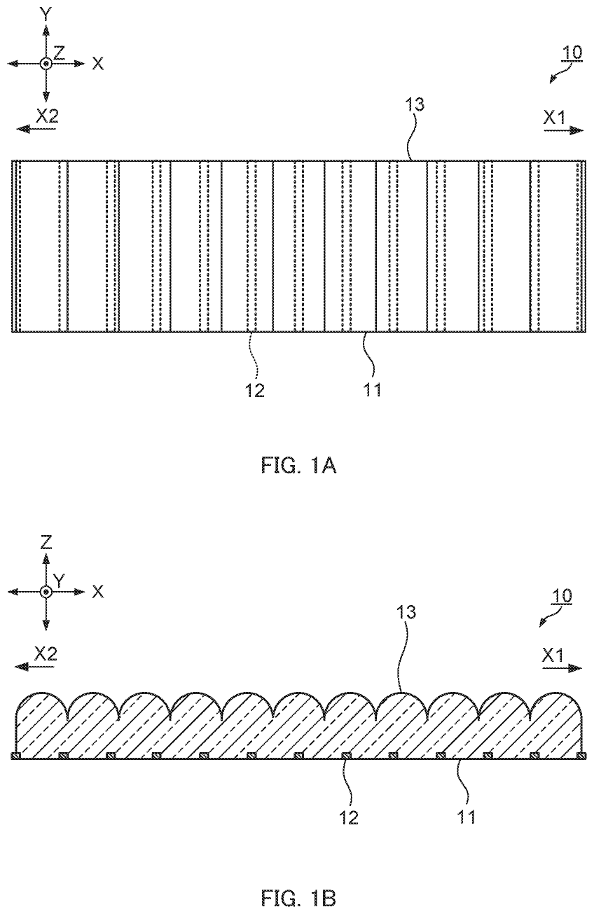

As in marker 10 illustrated in FIG. 1A and FIG. 1B, virtual detection object parts 1200A, 1200B and 1200C are disposed such that the greater the distance thereof from virtual detection object part 1200A of virtual reference cylindrical lens part 1120S in the X direction, the closer the positions of virtual detection object parts 1200A, 1200B and 1200C to the center side in the X direction with respect to virtual cylindrical lens part 1120. For example, virtual detection object parts 1200A, 1200B and 1200C are disposed such that the position of nth virtual detection object part with respect to virtual reference cylindrical lens part 1120S as 0th virtual detection object part satisfies P−nG (P represents the center-to-center distance (the distance between central axes CA) of virtual cylindrical lens parts 1120 in the X direction).

That is, in first virtual marker 1000, as in marker 10, virtual detection object parts 1200A, 1200B and 1200C are disposed to form marks that move in one direction between the both ends in the X direction when viewed from the convex surface side of virtual cylindrical lens part 1120 along the X direction while changing the angle. As with marker 10, first virtual marker 1000 is a marker in which the closer the viewing position to the end portion, the closer the position where the mark is projected.

As illustrated in FIG. 4B and FIG. 5A, detection object parts 120A in marker 100 are disposed in the same manner as virtual detection object parts 1200A in five virtual cylindrical lens parts 1120 disposed at the center including reference cylindrical lens part 1120S in first virtual marker 1000.

As illustrated in FIGS. 4B, 5A and 5B, detection object parts 120B in marker 100 are disposed in the same manner as virtual detection object parts 1200B of three virtual cylindrical lens parts 1120 on the other end side in first virtual marker 1000. Specifically, the arrangement of detection object parts 120B is identical to that of virtual detection object parts 1200B when three virtual cylindrical lens parts 1120 on the other end side in first virtual marker 1000 are disposed on the one end of side of reference cylindrical lens part 1120S in the above-mentioned five virtual cylindrical lens parts 1120 at the center, while maintaining the arrangement of virtual detection object parts 1200B in the X direction.

As illustrated in FIGS. 4B, 5B and 5C, detection object parts 120C in marker 100 are disposed in the same manner as virtual detection object parts 1200C of three virtual cylindrical lens parts 1120 on the one end side in first virtual marker 1000. Specifically, the arrangement of detection object parts 120C is identical to that of virtual detection object parts 1200C when three virtual cylindrical lens parts 1120 on the one end side in first virtual marker 1000 are adjacently disposed at three virtual cylindrical lens parts 1120 on the other end side in the above-mentioned five virtual cylindrical lens parts 1120 at the center in the X direction while the arrangement of virtual detection object parts 1200C are maintained.

As described above, the arrangement of detection object parts 120A of marker 100 is identical to that of virtual detection object parts 1200A of first virtual marker 1000 in the X direction, the arrangement of detection object parts 120B of marker 100 is identical to that of virtual detection object parts 1200B of first virtual marker 1000 in the X direction, and the arrangement of detection object parts 120C of marker 100 is identical to that of virtual detection object parts 1200C of first virtual marker 1000 in the X direction.

That is, practically, cylindrical lens parts 112 of marker 100 have a structure in which two virtual cylindrical lens parts 1120 of first virtual marker 1000 overlap each other. With this configuration, typically, two of detection object parts 120A, 120B and 120C are disposed in each cylindrical lens part 112 in marker 100.

In addition, in the X direction, detection object part 120B corresponding to virtual detection object part 1200B closest to the other end in the X direction overlaps detection object part 120C corresponding to virtual detection object part 1200C closest to the one end in the X direction at one end of reference cylindrical lens part 112S corresponding to detection object part 120A disposed on central axis CA.

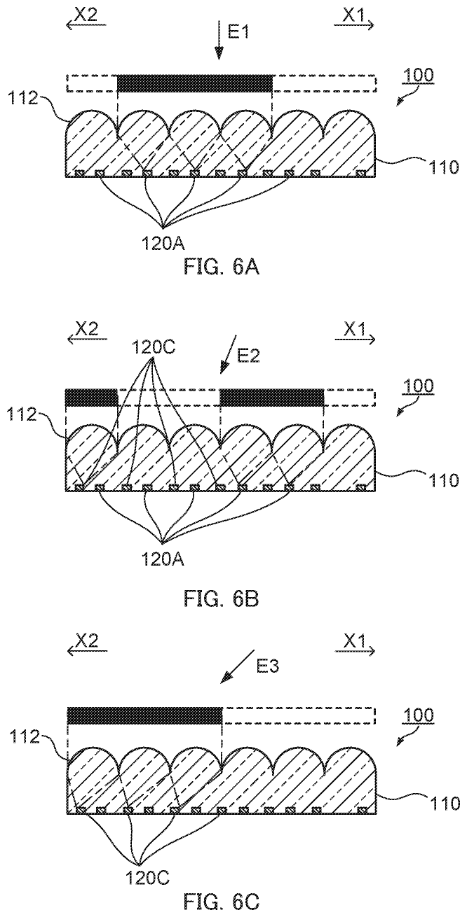

Next, a mark formed in marker 100 is described. FIG. 6A schematically illustrates a mark that is formed when marker 100 is viewed (in the direction of arrow E1) from directly above, FIG. 6B schematically illustrates a position of a mark when marker 100 is viewed (in the direction of arrow E2) at a slightly inclined angle from the one end side, and FIG. 6C schematically illustrates a position of a mark when marker 100 is viewed (in the direction of arrow E3) at a further inclined angle from the one end side.

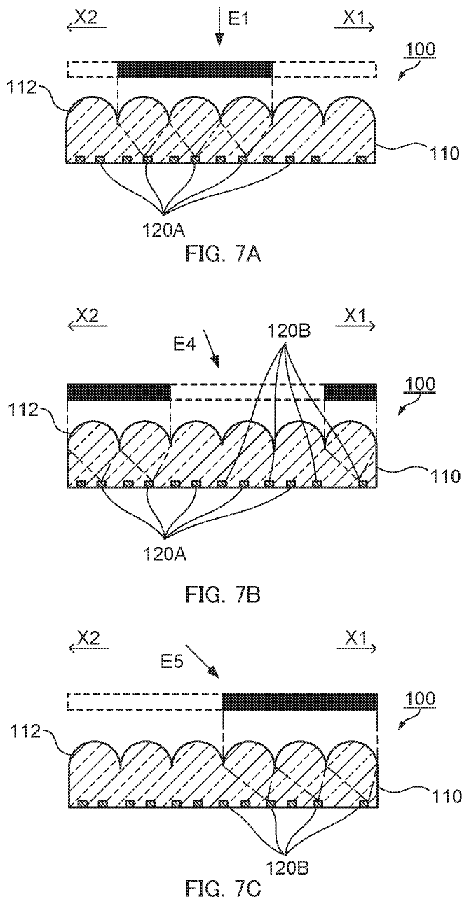

In addition, FIG. 7A schematically illustrates a mark when marker 100 is viewed (in the direction of arrow E1) from directly above, FIG. 7B schematically illustrates a mark when marker 100 is viewed (in the direction of arrow E4) at a slightly inclined angle from the other end side, and FIG. 7C schematically illustrates a mark when marker 100 is viewed (in the direction of arrow E5) at a further inclined angle from the other end side.

As with the mark that is projected in accordance with the positions of detection object parts 1200A, 1200B and 1200C of first virtual marker 1000, detection object parts 120A, 120B and 120C of marker 100 project a mark onto the surface of lenticular lens part 110.

For example, as illustrated in FIG. 6A, when marker 100 is viewed in the direction of arrow E1, detection object parts 120A disposed at a center portion in the X direction in first virtual marker 1000 are projected onto the surface of lenticular lens 110, and as a result, a mark is formed at a center portion of marker 100 in the X direction.

When marker 100 is viewed while relatively inclining marker 100 to the one end side, the projected mark of detection object part 120A moves from the center portion toward the one end of marker 100 in the X direction. Next, a projected mark of detection object parts 120C is formed.

Detection object parts 120C correspond to virtual detection object parts 1200C disposed on the one end side in the X direction of first virtual marker 1000. In marker 100, detection object parts 120C are disposed on the other end side in the X direction. With this configuration, detection object parts 120C form a mark that moves to the one end side, but the mark is formed on the other end side where detection object parts are 120C disposed. For example, as illustrated in FIG. 6B, when marker 100 is viewed in the direction of arrow E2, a projected mark of detection object parts 120A is formed at one end portion of marker 100, and a projected mark of detection object parts 120C is formed at the other end portion of marker 100.

When marker 100 is viewed while further inclining marker 100 toward the one end side, the projected mark of detection object parts 120C moves from the other end portion toward a center portion in the X direction in marker 100 as a projected mark of virtual detection object parts 1200C disposed at one end portion in the X direction in first virtual marker 1000 moves to one end (X1 direction) in the X direction. In this manner, as illustrated in FIG. 6C, when marker 100 is viewed in the direction of arrow E3, a projected mark of detection object parts 120C is formed in a region from the other end to the center portion of marker 100, for example.

With the above-mentioned configuration, when marker 100 is viewed while continuously changing the angle to marker 100 from the angle of arrow E1 to the angle of arrow E3, the mark moves from the center portion toward one end side, and then from the other end side to the center portion.

The same applies to the case that the marker is inclined to the opposite direction (i.e. the other end side). Specifically, when marker 100 is viewed while relatively inclining marker 100 to the other end side, the projected mark of detection object parts 120A moves from a center portion toward the other end of marker 100 in the X direction. Next, a projected mark of detection object part 120B corresponding to virtual detection object parts 1200B disposed at one end portion in first virtual marker 1000 is formed. Detection object parts 120B are disposed on the one end side in the X direction in marker 100, and accordingly, when marker 100 is viewed in the direction of arrow E4 for example, a projected mark of detection object parts 120A is formed in the other end portion of marker 100 and a projected mark of detection object part 120B is formed in one end portion of marker 100 as illustrated in FIG. 7B.

When marker 100 is viewed while relatively inclining marker 100 to the other end side, the projected mark of detection object parts 120B moves from the one end portion toward the center portion in the X direction in marker 100 as the projected mark of virtual detection object parts 1200B disposed on the other end portion in the X direction of first virtual marker 1000 moves toward the other end (in X2 direction) in the X direction. Thus, when marker 100 is viewed in the direction of arrow E5, the projected mark of detection object part 120B is formed in the region from one end to the center portion of marker 100 as illustrated in FIG. 7C.

With the above-mentioned configuration, when marker 100 is viewed while continuously changing the angle to marker 100 from the angle of arrow E1 to the angle of arrow E4 and the angle of arrow E5, the mark moves from the center portion toward the other end side, and then from one end side to the center portion.

As described above, when marker 100 is viewed while changing a viewing direction from a direction perpendicular to marker 100, marker 100 projects the mark such that the mark cyclically moves from the center portion to the one end side, and then from the other end side to the center portion so as to follow the movement of the viewing point in the X direction. The detection object parts that form a mark in marker 100 when marker 100 is viewed at a predetermined angle correspond to the virtual detection object parts that form a mark in first virtual marker 1000 when first virtual marker 1000 is viewed at that angle.

With this configuration, the length of marker 100 in the X direction is substantially half that of first virtual marker 1000. In addition, as with first virtual marker 1000, marker 100 projects a mark according to the position or the angle. Practically, marker 100 can detect a mark comparable to that of a marker having a length twice that of marker 100 in the X direction.

As described above, marker 100 includes a plurality of cylindrical lens parts 112 disposed in parallel, and a plurality of detection object parts 120A, 120B and 120C corresponding to cylindrical lens parts 112. Detection object parts 120A, 120B and 120C include detection object parts 120A corresponding to the first detection object part group, detection object parts 120B corresponding to the second detection object part group located on one end side in the X direction, and detection object parts 120C corresponding to the third detection object part group located on the other end side in the X direction. Here, first virtual marker 1000 is assumed as a virtual marker. First virtual marker 1000 includes a plurality of virtual cylindrical lens parts 1120 disposed in parallel. Further, first virtual marker 1000 includes virtual detection object parts 1200A, virtual detection object parts 1200B and virtual detection object parts 1200C that are disposed in association with virtual cylindrical lens parts 1120 so as to form a mark such that the mark moves in one direction between one end and the other in the X direction when the marker 100 is viewed from the convex surface side of virtual cylindrical lens part 1120 along the X direction while changing the angle. Virtual detection object parts 1200A correspond to a first virtual detection object part group located at a center portion in the X direction. Virtual detection object parts 1200B correspond to a second virtual detection object part group located at the other end side in the X direction. Virtual detection object parts 1200C correspond to a third virtual detection object part group located at one end side in the X direction. The arrangement of detection object parts 120A is identical to that of virtual detection object parts 1200A in the X direction. The arrangement of detection object parts 120B is identical to that of virtual detection object parts 1200B in the X direction. The arrangement of detection object parts 120C is identical to that of virtual detection object parts 1200C in the X direction. Further, detection object part 120B corresponding to virtual detection object part 1200B closest to the other end in the X direction and detection object part 120C corresponding to virtual detection object part 1200C closest to the one end in the X direction are disposed in association with reference cylindrical lens part 112S corresponding to a given detection object part 120A in detection object parts 120A. With this configuration, marker 100 can reduce (e.g. halve) the size of the portion for displaying the mark in comparison with marker 10 and first virtual marker 1000.

### Second Embodiment

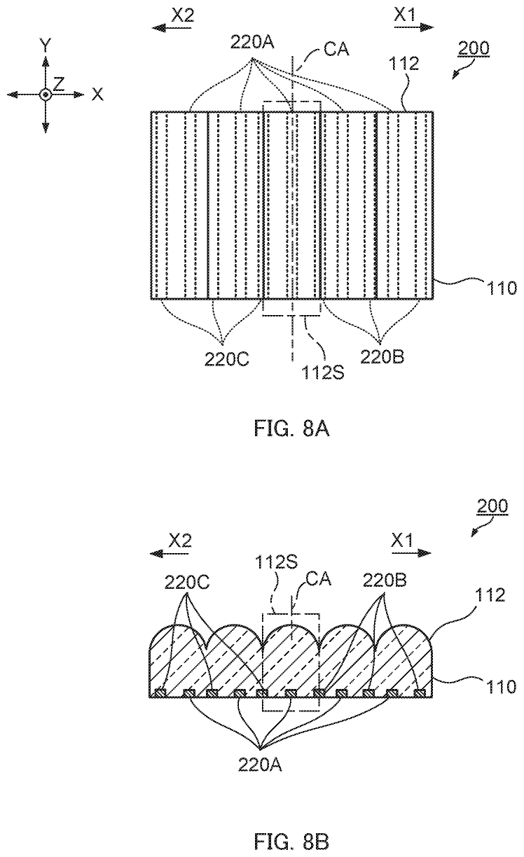

FIG. 8A is a plan view schematically illustrating a marker according to a second embodiment of the present invention, and FIG. 8B illustrates a cross-section of the marker illustrated in FIG. 8A along the X direction. As illustrated in FIG. 8A and FIG. 8B, marker 200 includes lenticular lens part 110, a plurality of cylindrical lens parts 112, reference cylindrical lens part 112S, and a plurality of detection object parts 220A, 220B and 220C. In marker 200, detection object part 220B closest to one end is disposed at the other end of reference cylindrical lens part 112, and detection object part 220C closest to the other end is disposed at one end of reference cylindrical lens part 112.

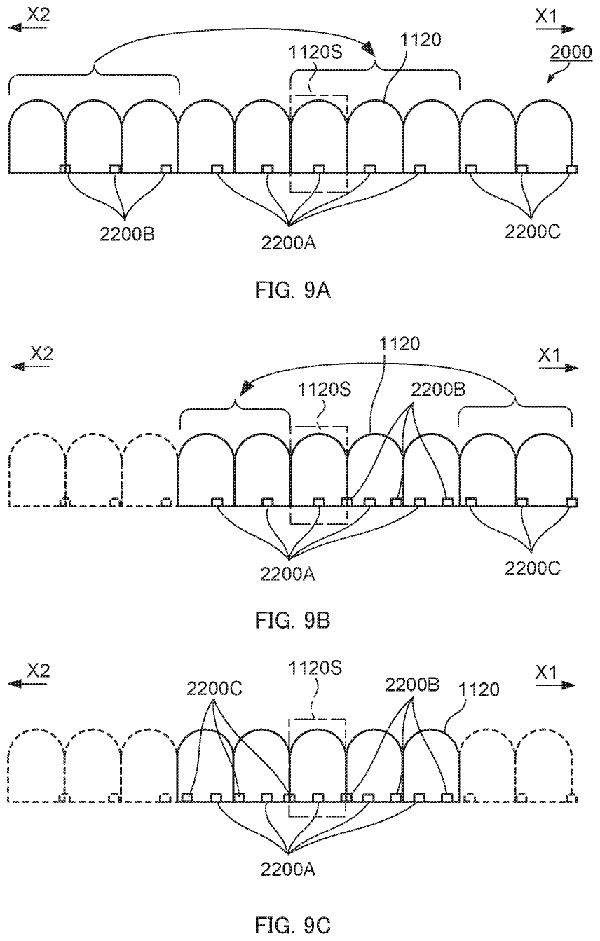

Arrangements of detection object parts 220A, 220B and 220C are described in more detail with reference to the drawings. FIG. 9A schematically illustrates an arrangement of virtual cylindrical lens parts and virtual detection object parts in the second virtual marker, FIG. 9B schematically illustrates a state where virtual detection object parts on the other end side are placed on the one end side in the second virtual marker, and FIG. 9C schematically illustrates a state where virtual detection object parts on the one end side are placed on the other end side in the second virtual marker.

As illustrated in FIG. 9A, second virtual marker 2000 includes a plurality of (e.g. 10) virtual cylindrical lens parts 1120 arranged in the X direction, each of which includes virtual detection object part 2200A, 2200B or 2200C. Second virtual marker 2000 further includes reference cylindrical lens part 1120S. As with marker 10, second virtual marker 2000 is a marker in which the closer the viewing position to the end portion, the closer the position where the mark is projected.

As illustrated in FIG. 8B and FIG. 9A, detection object parts 220A of marker 200 are disposed in the same manner as virtual detection object parts 2200A of five virtual cylindrical lens parts 1120 at the center including reference cylindrical lens part 1120S in second virtual marker 2000.

As illustrated in FIGS. 8B, 9A and 9B, detection object parts 220B of marker 200 are disposed in the same manner as virtual detection object parts 2200B of three virtual cylindrical lens part 1120 on the other end side in second virtual marker 2000. Specifically, the arrangement of detection object parts 220B is identical to that of virtual detection object parts 2200B when three virtual cylindrical lens parts 1120 on the other end side in second virtual marker 2000 are disposed over three virtual cylindrical lens parts 1120 located on the other end side in five virtual cylindrical lens parts 1120 at the center, while maintaining the arrangement of virtual detection object parts 2200B in the X direction.

As illustrated in FIGS. 8B, 9B and 9C, detection object parts 220C of marker 200 are disposed in the same manner as virtual detection object parts 2200C of two virtual cylindrical lens parts 1120 on the one end side in second virtual marker 2000. Specifically, the arrangement of detection object parts 220C is identical to that of virtual detection object parts 2200C when two virtual cylindrical lens parts 1120 on the one end side in second virtual marker 2000 are disposed over two virtual cylindrical lens parts 1120 located on the other end side in five virtual cylindrical lens parts 1120 at the center, while maintaining the arrangement of virtual detection object parts 2200C in the X direction.

That is, the arrangement of detection object parts 220A of marker 200 is identical to that of virtual detection object parts 2200A of second virtual marker 2000 in the X direction, the arrangement of detection object parts 220B of marker 200 is identical to that of virtual detection object parts 2200B of second virtual marker 2000 in the X direction, and the arrangement of detection object parts 220C of marker 200 is identical to that of virtual detection object parts 2200C of second virtual marker 2000 in the X direction.

In addition, object part 220B corresponding to the other end of virtual detection object part 2200B in the X direction detection and detection object part 220C corresponding to the one end of virtual detection object part 2200C in the X direction are disposed in reference cylindrical lens part 112S corresponding to one detection object part 220A disposed on central axis CA.

As with marker 100, when marker 200 is viewed while changing the viewing direction from the direction perpendicular to marker 200, marker 200 projects a mark such that the mark cyclically moves from the center portion to the one end side, and then from the other end side to the center portion so as to follow the movement of the viewing point in the X direction. Thus, marker 200 can also detect a mark comparable to that of a marker having a length twice that of marker 200.

### Third Embodiment

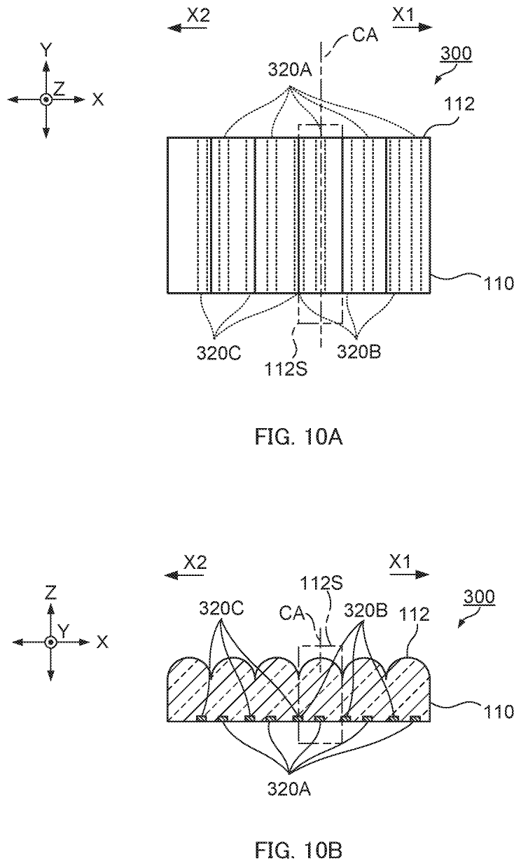

FIG. 10A is a plan view schematically illustrating a marker according to a third embodiment of the present invention, and FIG. 10B illustrates a cross-section of the marker illustrated in FIG. 10A along the X direction. As illustrated in FIG. 10A and FIG. 10B, marker 300 includes lenticular lens part 110, a plurality of cylindrical lens parts 112, reference cylindrical lens part 112S, and a plurality of detection object parts 320A, 320B and 320C. In marker 300, detection object part 320B closest to the one end overlaps detection object part 320C closest to the other end as one detection object part at the other end of reference cylindrical lens part 112S.

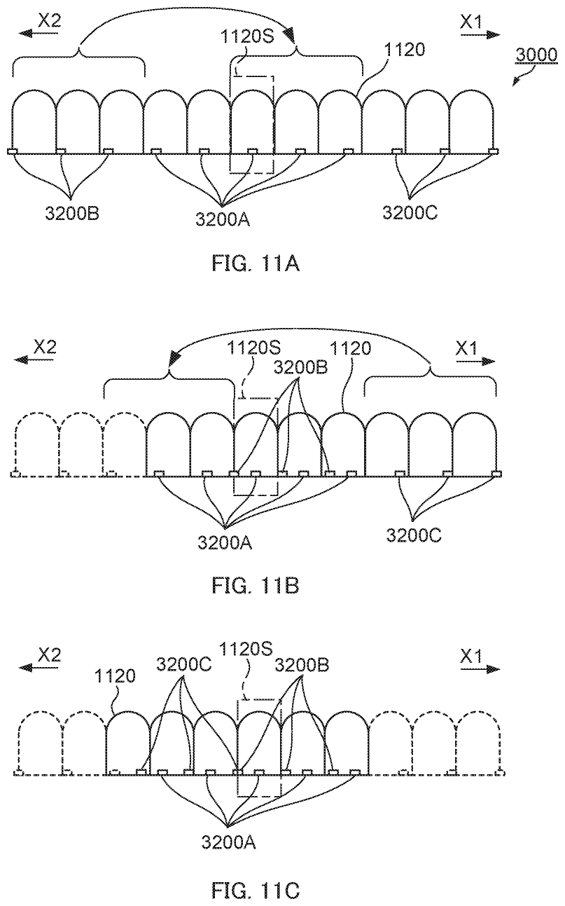

The arrangements of detection object parts 320A, 320B and 320C are described in more detail with reference to the drawings. FIG. 11A schematically illustrates an arrangement of the virtual cylindrical lens parts and the virtual detection object parts in the third virtual marker, FIG. 11B schematically illustrates a state where virtual detection object parts on the other end side are placed on the one end side in the third virtual marker, and FIG. 11C schematically illustrates a state where virtual detection object parts on the one end side are placed on the other end side in the third virtual marker.

As illustrated in FIG. 11A, third virtual marker 3000 includes the reference cylindrical lens part 1120S and a plurality of (e.g. 11) virtual cylindrical lens parts 1120 arranged in the X direction, each of which includes virtual detection object part 3200A, 3200B or 3200C.

Unlike in marker 10 illustrated in FIG. 1A and FIG. 1B, virtual detection object parts 3200A, 3200B and 3200C are disposed such that, with respect to the center set as detection object part 3200A of reference cylindrical lens part 1120S indicated with the dashed line in FIG. 11A to FIG. 11C, the greater the distance thereof in the X direction from the center, the closer the positions of virtual detection object parts 3200A, 3200B and 3200C to the end, with respect to virtual cylindrical lens part 1120. For example, each of virtual detection object parts 3200A, 3200B and 3200C is disposed such that nth virtual detection object part with respect to virtual reference cylindrical lens part 1120S set as 0th virtual detection object part satisfies P+nG (P is a center-to-center distance (distance between central axes CA)) of virtual cylindrical lens parts 1120 in the X direction.

Unlike the marker 10 and first and second virtual markers 1000 and 2000, third virtual marker 3000 projects the mark such that the position of the projected mark becomes farther as the viewing angle is oriented to an end side. Thus, as in marker 10, virtual detection object parts 3200A, 3200B and 3200C in third virtual marker 3000 are disposed to form marks that move in one direction between the both ends in the X direction when viewed from the convex surface side of virtual cylindrical lens part 1120 along the X direction while changing the angle.

As illustrated in FIG. 10B and FIG. 11A, detection object parts 320A of marker 300 are disposed in the same manner as virtual detection object parts 3200A of five virtual cylindrical lens parts 1120 at the center including reference cylindrical lens part 1120S in third virtual marker 3000.

As illustrated in FIGS. 10B, 11A and 11B, detection object parts 320B of marker 300 are disposed in the same manner as virtual detection object parts 3200B of three virtual cylindrical lens parts 1120 on the other end side in third virtual marker 3000. Specifically, the arrangement of detection object parts 320B is identical to that of detection object parts 3200B when three virtual cylindrical lens parts 1120 in third virtual marker 3000 on the other end side are disposed over three virtual cylindrical lens parts 1120 on the other end of side in five virtual cylindrical lens parts 1120 at the center while maintaining the arrangement of detection object parts 3200B in the X direction virtual.

As illustrated in FIGS. 10B, 11B and 11C, detection object parts 320C in marker 300 are disposed in the same manner as virtual detection object parts 3200C of three virtual cylindrical lens parts 1120 on the one end side in third virtual marker 3000. Specifically, the arrangement of detection object parts 320C is identical to that of virtual detection object parts 3200C when three virtual cylindrical lens parts 1120 on the other end side in third virtual marker 3000 are disposed on the other end side of reference cylindrical lens part 1120S in five virtual cylindrical lens parts 1120 at the center, while maintaining the arrangement of virtual detection object parts 3200C in the X direction.

That is, the arrangement of detection object parts 320A of marker 300 is identical to that of virtual detection object parts 3200A of third virtual marker 3000 in the X direction, the arrangement of detection object parts 320B of marker 300 is identical to that of virtual detection object parts 3200B of third virtual marker 3000 in the X direction, and the arrangement of detection object parts 320C of marker 300 is identical to that of virtual detection object parts 3200C of third virtual marker 3000 in the X direction.

In addition, detection object part 320B corresponding to virtual detection object part 3200B closest to the other end in the X direction and detection object part 320C corresponding to virtual detection object part 3200C closest to the one end in the X direction are disposed at reference cylindrical lens part 112S corresponding to one detection object part 320A disposed on central axis CA.

As with markers 100 and 200, marker 300 projects a mark such that the mark cyclically moves from the center portion when marker 300 is viewed in a direction inclined with respect to a direction perpendicular to marker 300. Unlike markers 100 and 200, marker 300 projects a mark such that the mark cyclically moves in a direction away from the side to which the viewing point is moved in the X direction when marker 300 is viewed in a direction inclined to the one end side or the other end side with respect to a direction perpendicular to marker 300. With this configuration, marker 300 can detect a mark comparable to that of a marker having a length twice that of marker 300 as with marks 100 and 200 except for the movement direction of the mark to be observed.

Note that the cylindrical lens part may be an aspherical lens part. A configuration in which the lens part is an aspherical lens part means that the actual optical shape of the convex surface part in the cylindrical lens part in a cross-section along the XZ plane is not an arc, but a curve with curves of different curvature radiuses connected with each other. Preferably, in a cross-section of the cylindrical lens part along the XZ plane, the convex surface part of the aspherical lens part is a curved surface whose curvature radius increases as the distance of the convex surface part from the optical axis (central axis CA) in the X direction increases.

In addition, the detection object part may have a configuration other than the groove and the coloring part. For example, the detection object part may include a protrusion and a coloring part, or may be composed only of a coloring part such as a colored slender resin housing disposed in a transparent resin molded body. Further, while the coloring part includes a solidified coating material in the above-mentioned configuration, the coloring part may be a colored sheet.

In addition, since the detection object part needs only be detected as an image as a mark when viewed from the lenticular lens part side, the detection object part needs only to be optically identifiable with respect to the rear surface of the lenticular lens part. For example, the rear surface part of the lenticular lens part may be irregularities formed by minute pyramidal prisms or a reflection surface formed by a metal vapor deposition film, or, may have a color other than those of the above-mentioned coloring parts. In this case, the detection object part may be or may not be colored as long as the detection object part is optically identifiable.

While, in the above-described embodiment, the detection object parts are disposed in the virtual marker with the reference cylindrical lens part located at the center such that the center-to-center distance between the detection object parts adjacent to each other slightly decreases or increases as the distance from the reference cylindrical lens part increases, the center-to-center distance of the detection object parts adjacent to each other may be appropriately set as long as the above-mentioned desired behavior of the mark can be ensured. For example, the marker may include a plurality of detection object parts disposed to have a center-to-center distance equal to the center-to-center distance between the cylindrical lens parts adjacent to each other in any of the first to third detection object part groups.

Further, a cylindrical lens part having one of detection object parts 120A to 120C may further include another one of detection object parts 120A to 120C.

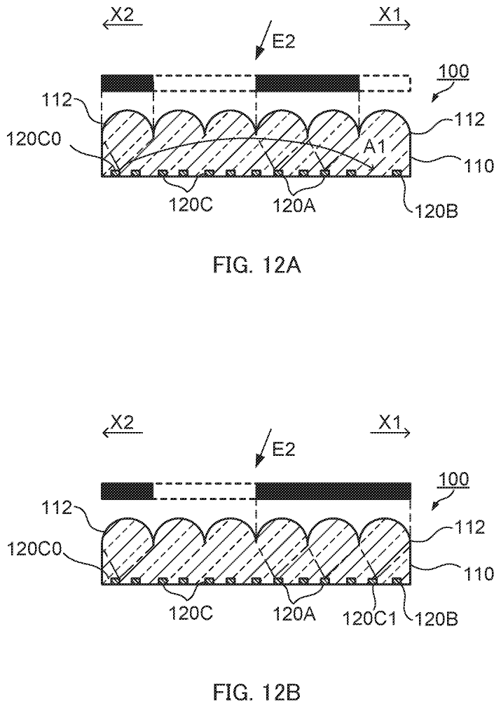

For example, FIG. 12A schematically illustrates a mark when marker 100 of the first embodiment is viewed in direction E2, and is substantially the same as FIG. 6A. Cylindrical lens part 112 at one end of marker 100 includes one detection object part 120B.

Here, detection object part 120C of cylindrical lens part 112 at the other end of marker 100 is denoted with “120C0”, and the detection object part 12000 is additionally disposed in cylindrical lens part 112 located at one end. The detection object part 120C disposed in this manner is denoted with “120C1”. With the detection object part 120C1 thus added, cylindrical lens part 112 at one end of marker 100 further includes detection object part 120C (120C1) in addition to originally disposed detection object part 120B.

Cylindrical lens part 112 located at one end of marker 100 additionally includes detection object part 120C1, and therefore, when marker 100 is viewed in direction E2, the mark is observed such that the mark moves to one end of marker 100 as illustrated in FIG. 12B. That is, a configuration in which a certain cylindrical lens part 112 is further provided with the detection object part 120C0 of a next cylindrical lens part 112 in the mark movement direction is preferable in view of achieving the same movement range regardless of the inclination direction of marker 100, or in view of clarifying the movement direction of marker 100.

This application is entitled to and claims the benefit of Japanese Patent Application No. 2016-165672 filed on Aug. 26, 2016, the disclosure each of which including the specification, drawings and abstract is incorporated herein by reference in its entirety.

### INDUSTRIAL APPLICABILITY

The marker according to the present invention is suitable as a position detecting marker (or an angle detecting marker) for recognizing the position, orientation and the like of an object, and is suitable for detecting the position or angle in a further limited space. Accordingly, the present invention is expected to contribute to development in the technical fields of the above-mentioned marker.

### REFERENCE SIGNS LIST

10, 100, 200, 300 Marker
11, 110 Lenticular lens part
12, 120A to 120C, 120C0, 120C1, 220A to 220C, 320A to 320C Detection object part
13, 112 Cylindrical lens part
112S, 1120S Reference cylindrical lens part
1000 First virtual marker
1120 Virtual cylindrical lens part
1200A to 1200C, 2200A to 2200C, 3200A to 3200C Virtual detection object part
2000 Second virtual marker
3000 Third virtual marker
CA Central axis

What is claimed is:

1. A marker comprising:
a plurality of cylindrical lens parts disposed in parallel; and
a plurality of detection object parts disposed in association with the plurality of cylindrical lens parts, wherein
the plurality of detection object parts include:
a first detection object part group,
a second detection object part group disposed on one end side in an arrangement direction of the plurality of cylindrical lens parts, and
a third detection object part group disposed on the other end side in the arrangement direction,
with respect to a virtual marker including a plurality of virtual cylindrical lens parts disposed in parallel and a plurality of virtual detection object parts disposed in association with the plurality of virtual cylindrical lens parts, the plurality of virtual detection object parts being disposed such that, when the virtual marker is viewed from a convex surface side of the plurality of virtual cylindrical lens parts while changing a viewing angle along a virtual arrangement direction of the plurality of virtual cylindrical lens parts, the plurality of virtual detection object parts form a mark that moves in one direction between one end and the other end of the plurality of virtual cylindrical lens parts in the virtual arrangement direction, the plurality of virtual detection object parts including a first virtual detection object part group disposed at a center portion in the virtual arrangement direction, a second virtual detection object part group disposed on the other end side in the virtual arrangement direction, and a third virtual detection object part group disposed on one end side in the virtual arrangement direction,
an arrangement of the detection object parts of the first detection object part group is identical to an arrangement of the virtual detection object parts of the first virtual detection object part group in the virtual arrangement direction,
an arrangement of the detection object parts of the second detection object part group is identical to an arrangement of the virtual detection object parts of the second virtual detection object part group in the virtual arrangement direction,
an arrangement of the detection object parts of the third detection object part group is identical to an arrangement of the virtual detection object parts of the third virtual detection object part group in the virtual arrangement direction, and
a first detection object part and a second detection object part are disposed in association with one of the plurality of cylindrical lens parts corresponding to any one of the detection object part in the first detection object part group, the first detection object part being one of the plurality of detection object parts of the second detection object part group, the first detection object part corresponding to the virtual detection object part closest to the other end in the virtual arrangement direction in the second virtual detection object part group, the second detection object part being one of the plurality of detection object parts of the third detection object part group, the second detection object part corresponding to the virtual detection object part closest to the one end in the virtual arrangement direction in the third virtual detection object part group.
